(19) United States
(12) Patent Application Publication
(10) Pub. No.: US 2025/0292061 A1
(43) Pub. Date: Sep. 18, 2025

(54) SYSTEM AND METHOD FOR PROCESSING STILL IMAGES USING RECURRENT NEURAL NETWORKS

(71) Applicant: Synaptics Incorporated, San Jose, CA (US)

(72) Inventors: Dmitri Lvov, Ramat Hasharon (IL); Yair Smadar, Herzliya (IL); Ran Zvi Bezen, Ramat Hasharon (IL)

(73) Assignee: Synaptics Incorporated, San Jose, CA (US)

(21) Appl. No.: 19/074,833

(22) Filed: Mar. 10, 2025

Related U.S. Application Data
(60) Provisional application No. 63/565,274, filed on Mar. 14, 2024.

(51) Int. Cl. G06N 3/044; G06N 3/0499; G06V 10/82

(52) U.S. Cl. CPC G06N 3/044; G06N 3/0499; G06V 10/82

(57) ABSTRACT

Methods, systems, and apparatus are disclosed for processing still images using recurrent neural networks (RNNs). The method can include: generating, by a first forward RNN layer module, first RNN output data from still image data; generating, by a first reverse layer module, first reverse layer data from the first RNN output data; generating, by a first backward RNN layer module, second RNN output data from the first reverse layer data, wherein machine learning model weights are shared between the first forward RNN layer module and the first backward RNN layer module; generating, by a second reverse layer module, output data from the second RNN output data; and processing, by a machine learning backbone module, the still image data using the output data, wherein the generating and the processing are performed by at least one data processor on a resource-constrained hardware device.

### CROSS-REFERENCE TO RELATED APPLICATIONS

This application claims the benefit of U.S. Provisional Application No. 63/565,274, entitled “System and Method for Processing Still Images using Recurrent Neural Networks,” filed on Mar. 14, 2024, which is incorporated by reference herein in its entirety.

### BACKGROUND

The field of computer vision has seen remarkable advancements thanks to artificial intelligence, especially using Convolutional Neural Networks (CNNs). These networks have become the go-to method for making sense of images, capturing the intricate patterns and details within them. More recently, transformers, first introduced for text inputs and later for images, have started to play a significant role, offering powerful capabilities but at the cost of needing much larger models. This requirement makes them less ideal for use in devices with limited resources, like small gadgets and embedded systems.

A Recurrent Neural Network (RNN) is a type of artificial neural network that uses sequential data or time series data. RNNs are distinguished by their “memory,” as they take information from prior inputs to influence the current input and output. While traditional deep neural networks assume that inputs and outputs are independent of each other, the output of RNNs depends on the prior elements within the sequence. As RNNs are used on time-sequences, RNNs are not used in models for processing still images. Rather, the conventional method applied to still images in deep learning relies on CNN architectures or transformers, the models for which require a significant number of parameters and are very large. Such large models are not designed for resource-constrained hardware, such as embedded devices.

### SUMMARY

The present invention is directed to a system and method for processing still images using Recurrent Neural Networks (RNNs) for resource-constrained devices. According to embodiments of the present invention, RNNs can effectively process still images by interpreting the pixels as a sequence. In some implementations of the present invention, two RNN layers can be used-one for the x-axis and one for the y-axis-instead of a single Convolutional Neural Network (CNN) layer or several CNN layers. Exemplary embodiments of the present invention can be particularly advantageous for compact machine learning models designed for embedded systems, where resources are limited. According to embodiments of the present invention, a custom variant of the Bidirectional RNN (BiRNN), called Weight-Shared Bi-Directional RNN (WS-BiRNN), can utilize shared machine learning model weights for both forward and backward directions. WS-BiRNN can enable the use of fewer model weights while simultaneously accounting for both forward and backward directions during training. WS-BiRNN can save memory compared to BiRNN, as BiRNN uses two blocks of RNN and, therefore, double the number of machine learning model weights. Embodiments of the present invention can also use an extension of RNN for two-dimensional (2D) inputs, such as still images, using a Separable RNN (SRNN). The combination of SRNN and WS-BiRNN is referred to as SWS-BiRNN (Separable Weight-Shared Bidirectional RNN). Thus, embodiments of the present invention can conserve memory due to the machine learning model having a reduced number of model weights and enhance performance while maintaining the same weight count in the model. Additionally, the use of an RNN-based machine learning model can require fewer layers, which potentially allows for quicker inference times. Exemplary embodiments of the present invention can be used for any suitable computer vision processing task for still images, including, for example, object detection, classification, estimation, and the like.

An example method includes generating, by a first forward RNN layer module, first RNN output data from still image data; generating, by a first reverse layer module, first reverse layer data from the first RNN output data; generating, by a first backward RNN layer module, second RNN output data from the first reverse layer data, wherein machine learning model weights are shared between the first forward RNN layer module and the first backward RNN layer module; generating, by a second reverse layer module, output data from the second RNN output data; and processing, by a machine learning backbone module, the still image data using the output data, wherein the generating and the processing are performed by at least one data processor on a resource-constrained hardware device.

In some aspects, the first RNN output data includes a one-dimensional sequence of features associated with a still image for processing using the RNNs. In some aspects, the first RNN output data includes an output of a first RNN being applied to the one-dimensional sequence. In some aspects, the first reverse layer data includes the first RNN output data and first reversed data, the first reversed data including the one-dimensional sequence of features expressed in a reversed order. In some aspects, the second RNN output data includes the first RNN output data and an output of the first RNN being applied to the first reversed data. In some aspects, the second reverse layer data includes a sum of the first RNN output data and a reversed order output of the first RNN being applied to the first reversed data. In some aspects, the second reverse layer data includes Weight-Shared Bi-Directional RNN (WS-Bi-RNN) data given as WS-BiRNN(X)=RNN₁(X)+Flip(RNN₁(Flip(X))), where X is the one-dimensional sequence of features, RNN₁(⋅) is an operator applying the first RNN to its operand, and Flip(⋅) is an operator which reverses the order of its operand.

In some aspects, the still image data includes a two-dimensional sequence of feature vectors associated with a still image for processing using the RNNs. In some aspects, the method 300 further includes generating, by a second forward RNN layer module, third RNN output data from the second reverse layer data, generating, by a third reverse layer module, third reverse layer data from the third RNN output data, generating, by a second backward RNN layer module, fourth RNN output data from the third reverse layer data, wherein machine learning model weights are shared between the second forward RNN layer module and the second backward RNN layer module, and generating, by a fourth reverse layer module, fourth reverse layer data from the fourth RNN output data, wherein the machine learning backbone module further processes the still image data based at least in part on the fourth reverse layer data.

In some aspects, the third RNN output data includes an output of a second RNN being applied to the second reverse layer data, the second RNN being different from an RNN associated with the first forward RNN layer module and the first backward RNN layer module. In some aspects, the third reverse layer data includes the third RNN output data and second reversed data, the second reversed data including the second reverse layer data expressed in a reversed order. In some aspects, the fourth RNN output data includes the third RNN output data and an output of the second RNN being applied to the second reversed data. In some aspects, the second reverse layer data includes Weight-Shared Bi-Directional RNN (WS-BiRNN) data given as WS-BiRNN₁(X)=RNN₁(X)+Flip(RNN₁(Flip(X))), where X is the two-dimensional sequence of features, RNN₁(⋅) is a first RNN operator associated with the first forward RNN layer and the first backward RNN layer, the first RNN operator configured to operate on rows of the two-dimensional sequence of features, and Flip(⋅) is an operator which reverses the order of its operand. In some aspects, the fourth reverse layer data includes WS-BiRNN’1(Y)=RNN₂(Y+Flip(RNN₂(Flip(Y))), where Y is the second reverse layer data, RNN₂(⋅) is a second RNN operator which applies the second RNN to its operand, the second RNN operator configured to operate on columns of the two-dimensional sequence of features, and Flip(⋅) is an operator which reverses the order of its operand. In some aspects, the fourth reverse layer data includes Separable Weight-Shared Bi-Directional RNN (SWS-BiRNN) data given as SWS-BiRNN(X)=WS-BiRNN₂(WS-BiRNN₂(X)^{T})^{T}.

### BRIEF DESCRIPTION OF THE DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a block diagram illustrating an example system for processing still images using Recurrent Neural Networks (RNNs);

FIG. 2 is a block diagram illustrating a data flow for a Separable Weight-Shared Bi-Directional Recurrent Neural Network (SWS-BiRNN) layer unit;

FIG. 3 is a flowchart of an example method for processing still images using SWS-BiRNN layer units; and

FIG. 4 is a block diagram of an example computing device that may perform one or more of the operations described herein, in accordance with the present embodiments.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Computer vision processing tasks performed on still images (e.g., object detection and the like) are widely used for many applications, such as, for example, security cameras and the like. Performing computer vision processing tasks on the edge has multiple advantages, including, for instance, improvements in latency, privacy, and cost. However, such solutions can be resource-intensive, necessitating both considerable computing power and substantial memory consumption. For example, Convolutional Neural Network (CNN) based machine learning models, such as YOLO and the like, are conventionally used for object detection in still images due to their efficiency and accuracy. Recurrent Neural Networks (RNNs) are not used in machine learning models for object detection in still images, as RNN in computer vision processing tasks has been generally limited to time-sequences. CNN-based object detection models typically require a significant number of parameters and are very large. These limitations make deployment in resource-constrained environments, such as edge devices, embedded systems and the like, particularly challenging. While there are numerous strategies to mitigate these challenges, such as reducing the number of filters or layers, implementing pruning techniques, or using quantization methods, there are trade-offs to consider. Often, these adjustments can help fit the network to resource-constrained devices, but can lead to a decline in the overall accuracy of the network.

Despite the popularity of CNNs and transformers, there is an increased need for alternatives that can work well in resource-limited environments. This is where RNNs can be used. RNNs are known for their ability to handle data that comes in sequences, like sentences in a text or steps in a video. However, RNNs have not been widely used for processing still images, mainly because still images do not naturally come in sequences.

It is noted that RNN layers generally require fewer parameters compared to standard CNN layers, given the same number of layers. This is because RNNs can process data sequentially, allowing them to reuse a set of parameters across all the inputs in the sequence. For example, if an RNN layer processes an image pixel by pixel, it reuses its weights for each pixel, unlike a CNN that applies a separate set of filters across the input. This characteristic makes RNNs particularly suitable for edge environments, where model size and efficiency are crucial.

Additionally, the memory component of RNNs endows them with a large receptive field, enabling a single RNN layer to potentially replace several CNN layers. This is advantageous, as it reduces inference time by minimizing the data transfer overhead between consecutive layers. In neural networks, the output of each layer must be stored and then passed as input to the next layer, incurring a delay. Replacing several CNN layers with an RNN layer saves these data transfers, potentially speeding up the inference process.

The present invention is directed to a system and method for processing still images using RNNs, which can address both processing and memory limitations for resource-constrained devices. RNN layers can be used for inference on still image inputs, instead of the conventional practice of using RNNs for sequences of images. According to embodiments of the present invention, RNNs can effectively process still images by interpreting the pixels as a sequence. In some implementations of the present invention, two RNN layers can be used—one for the x-axis and one for the y-axis—instead of a single CNN layer or several CNN layers. The advantages of using RNN over CNN for processing still images for resource-constrained devices include, for example, the need for less model parameters per layer and less layers with the same receptive field, which translates to less overall model parameters. In addition, a reduced number of model parameters in the present invention can translate to less operations per inference. In other words, exemplary embodiments of the present invention can be particularly advantageous for compact machine learning models designed for embedded systems, where resources are limited. In a conventional architecture of, for example, a YOLOv5 model, a CNN backbone communicates with a plurality of CNN heads, with each CNN head including one to four convolutional layers. By substituting CNN layers with RNN in a fully convolutional computer vision processing model, better accuracy can be obtained for small machine learning models and achieve the same or similar accuracy for larger models.

According to embodiments of the present invention, a custom variant of the Bidirectional RNN (BiRNN), called Weight-Shared Bi-Directional RNN (WS-BiRNN), can utilize shared machine learning model weights for both forward and backward directions. WS-BiRNN can enable the use of fewer model weights while simultaneously accounting for both forward and backward directions during training. WS-BiRNN can save memory compared to BiRNN, as BiRNN uses two blocks of RNN and, therefore, double the number of machine learning model weights. Embodiments of the present invention can also use an extension of RNN for two-dimensional (2D) inputs, such as still images, using a Separable RNN (SRNN). The combination of SRNN and WS-BiRNN will be referred to as SWS-BiRNN (Separable Weight-Shared Bidirectional RNN) in the present disclosure. Thus, embodiments of the present invention can conserve memory due to the machine learning model having a reduced number of model weights and enhance performance while maintaining the same weight count in the model. Additionally, the use of an RNN-based machine learning model can require fewer layers, which potentially allows for quicker inference times. Exemplary embodiments of the present invention can be used for any suitable computer vision processing task for still images, including, for example, object detection, classification, estimation, and the like.

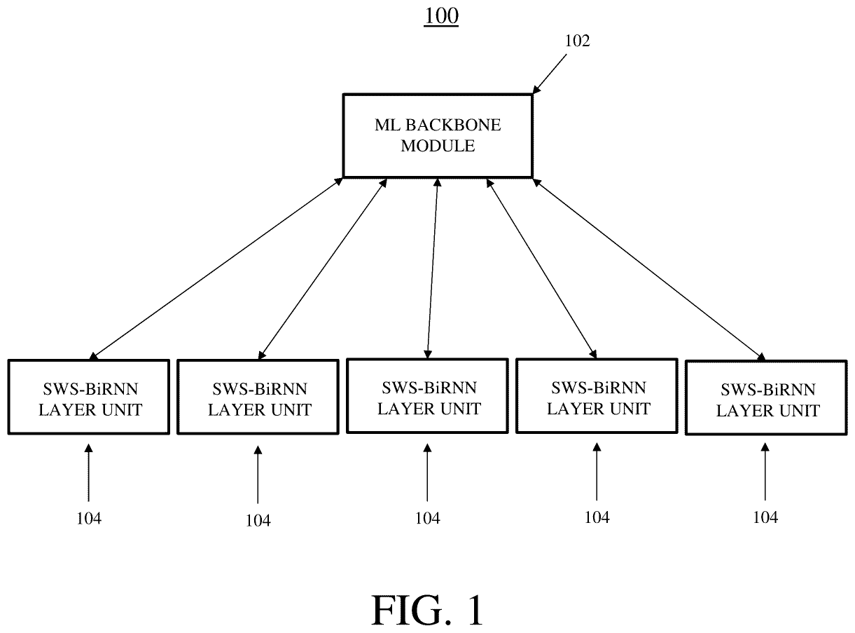

FIG. 1 is a block diagram illustrating an example system 100 for processing still images using RNNs. The system 100 can include a machine learning (ML) backbone module 102 in communication with a plurality of SWS-BiRNN layer units 104. In some implementations of the present invention, the ML backbone module 102 can comprise a CNN backbone, although other suitable ML models are possible for ML backbone module 102. For each SWS-BiRNN layer unit 104, it is noted that the definition of an RNN layer unit is given in Equation (1):

$${h}_{t} = tan h ( {W}_{ih} {x}_{t} + {b}_{ih} + {W}_{hh} {h}_{t - 1} + {b}_{hh} ) \qquad ( 1 )$$

where xₜ∈ [symbol] ^{C}^{ᵢₙ} and hₜ∈ [symbol] ^{C}^{ₒᵤₜ} are the input and output features at time t, respectively, and hₜ₋₁ is a hidden state of the RNN layer, stored from its previous iteration. The learnable model weights are Wᵢₕ∈ [symbol] ^{C}^{ₒᵤₜ}^{×C}^{ᵢₙ} and Wₕₕ∈ [symbol] ^{C}^{ₒᵤₜ}^{×C}^{ₒᵤₜ}. The learnable biases are b^{ih}, bₕₕ∈ [symbol] ^{C}^{ₒᵤₜ}. The non-linearity chosen for Equation (1) can be tanh, but any suitable non-linear function that is capable of operating element-wise can be used. A concise notation for Equation (1) can be expressed as in Equation (2):

$$H = RNN ( X ) \qquad ( 2 )$$

where X={xₜ}ₜ₌₁^{L} and H={hₜ}ₜ₌₁^{L} are 2D tensors of shape L×Cᵢₙ and L×Cₒᵤₜ, respectively. The batch dimension is neglected merely for conciseness and clarity of the discussion, but would be present in actual training.

To address the two dimensions of a still image, some implementations of the present invention can use an approach similar to a separable convolution, in which two one-dimensional (1D) convolutions are used instead of a single 2D convolution, with one convolution on the x-axis and one convolution on the y-axis. In a conventional network designed to run on still images, the input for 2D convolution layers is a three-dimensional (3D) tensor, with the dimensions H×W×Cᵢₙ. In embodiments of the present invention, the input can be treated as a 2-dimensional sequence of feature vectors, as defined in Equation (3):

$${X = \{ {x}_{jk} ]}_{j = 1 ¨ H , k = 1 ¨ W} {x}_{jk} ∈ {ℝ}^{{C}_{in}} \qquad ( 3 )$$

The RNN layer is well-defined when operating independently on every row, as given in Equation (4):

$${h}_{jk} = {\{ RNN ( X ) \}}_{jk} = tan h ( {W}_{ih} {x}_{jk} + {b}_{ih} + {W}_{hh} {h}_{j , k - 1} + {b}_{hh} ) \qquad ( 4 )$$

In some implementations of the present invention, the same model weights and biases can be used for every row, as would be the case in a separable convolution. This produces the intermediate result given in Equation (5):

$${H}_{1} = {RNN}_{1} ( X ) \qquad ( 5 )$$

The second RNN layer can operate on the columns of H₁ or the rows of H₁^{T}, as given in Equation (6):

$${H}_{2} = {{RNN}_{2} ( {H}_{1}^{T} )}^{T} \qquad ( 6 )$$

where the transpose operation operates on the height and width dimensions, as given in Equation (7):

$${\{ {X}^{T} \}}_{jk} = {\{ X \}}_{kj} = {x}_{kj} \qquad ( 7 )$$

Finally, a SRNN is defined as in Equation (8):

$$SRNN ( X ) = {{RNN}_{2} ( {{RNN}_{1} ( X )}^{T} )}^{T} \qquad ( 8 )$$

In some implementations of the present invention, RNN₁ and RNN₂ can use different model weights for the rows and columns. In an alternative embodiment, RNN₁ and RNN₂ can use the same model weights for the rows and columns.

Convolution layers have a symmetric receptive field around the center of their kernel. In contrast, an RNN layer has a one-sided receptive field, meaning that the calculation of hₜ, through the recursive usage of hₜ₋₁, includes only the previous inputs {xₜ₋ₖ:k∈ [symbol] }. A solution to such a limitation is to use BiRNN, which contains two RNN layers, one operating on the input sequence as in Equation (1) and the other operating on the same sequence in a reverse direction. According to embodiments of the present invention, a WS-BiRNN layer can be used in each of the SWS-BiRNN layer units 104. WS-BiRNN is similar to BiRNN, except that the same model weights are used for both directions, as given in Equation (9):

$$WS - BiRNN ( X ) = {RNN}_{1} ( X ) + Flip ( {RNN}_{1} ( Flip ( X ) ) ) \qquad ( 9 )$$

where the Flip operation reverses the order of the sequence X, or, in the case of two dimensions, the order of the rows of X, as given in Equation (10):

$${\{ Flip ( X ) \}}_{jk} = {\{ X \}}_{j , W + 1 - k} \qquad ( 10 )$$

Such a formulation forces the effective model weights multiplying {xₜ} in the calculation of hₜ to be symmetric around t. For each SWS-BiRNN layer unit 104, the extension to two dimensions (e.g., for a still image or the like) for SWS-BiRNN is defined in Equation (11):

$$SWS - BiRNN ( X ) = WS - {{BiRNN}_{2} ( WS - {{BiRNN}_{1} ( X )}^{T} )}^{T} \qquad ( 11 )$$

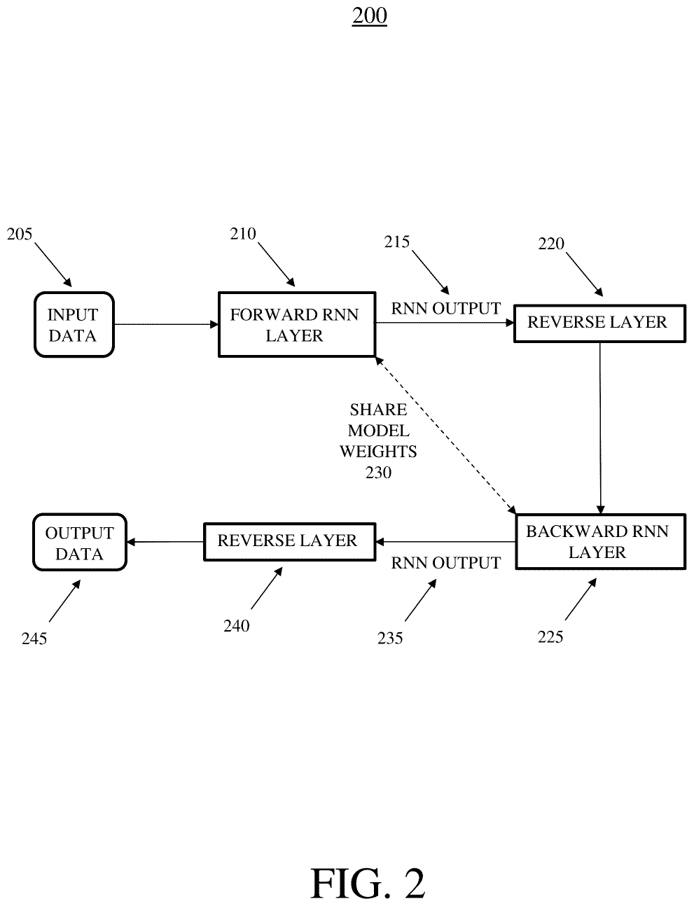

FIG. 2 is a block diagram illustrating a data flow 200 for the SWS-BiRNN layer unit 104. As illustrated in FIG. 2, input data 205 (e.g., data from a still image) can be applied to a forward RNN layer block 210. The forward RNN layer block 210 can generate a first RNN output 215. The first RNN output 215 can be applied to a first reverse layer block 220. The output of the first reverse layer block 220 can be applied to the backward RNN layer block 225. According to embodiments of the present invention, the SWS-BiRNN layer units 104 can use the same model weights for both forward and backward directions. Consequently, the forward RNN layer block 210 and the backward RNN layer block 225 can share model weights 230. The backward RNN layer block 225 can generate a second RNN output 235. The second RNN output 235 can be applied to a second reverse layer block 240. The second reverse layer block 240 can generate the output data 245 of the data flow 200 for the SWS-BiRNN layer unit 104. The output data 245 from each or any of the SWS-BiRNN layer units 104 of system 100 in FIG. 1 can be used by the ML backbone module 102 to process the still image data of input data 205. For example, the ML backbone module 102 can perform object detection, classification, estimation, or other suitable computer vision processing tasks on the still image data using the output data 245.

Exemplary embodiments of the present invention can conserve memory due to the machine learning model having a reduced number of weights and enhance performance while maintaining the same weight count in the model. It is noted that SWS-BiRNN has the same number of model parameters as SRNN. The number of model parameters in an SRNN layer is given by Equation (12):

$${SRNN}_{parameters} = 2 ( {C}_{in} \cdot {C}_{out} + {C}_{out}^{2} ) + 4 {C}_{out} \qquad ( 12 )$$

In some implementations of the present invention, the two bias vectors, bᵢₕ and bₕₕ, can be held separately. In an alternative embodiment, the two bias vectors can be combined into a single vector. The number of parameters in a 2D convolution (Conv2D) layer is given by Equation (13):

$$Conv 2 {D}_{parameters} = {C}_{in} \cdot {C}_{out} \cdot {k}^{2} + {C}_{out} \qquad ( 13 )$$

where k is the kernel size. Using Equations (12) and (13), the ratio of the number of parameters is given by Equation (14):

$$\frac{{SRNN}_{parameters}}{Conv 2 {D}_{parameters}} = \frac{2 ( {C}_{in} + {C}_{out} ) + 4}{{k}^{2} \cdot {C}_{in} + 1} \qquad ( 14 )$$

Since Cₒᵤₜ is only present in the numerator of Equation (14), in cases when Cₒᵤₜ is considerably larger than Cᵢₙ, the number of parameters in a SRNN layer may be larger than in a Conv2D layer with a small kernel. However, when the number of output and input channels is similar, but assuming it is much larger than 1, the ratio becomes 4/k², which is generally smaller than 1 (except for a pointwise convolution). Merely for purposes of illustration and not limitation, the following example values can be used:

$${C}_{in} = {C}_{out} = 16 , k = 3 \qquad ( 15 )$$

Using the exemplary values from Equations (15) in Equation (14) results in the following:

$$\frac{{SRNN}_{parameters}}{Conv 2 {D}_{parameters}} = \frac{2 ( 16 + 16 ) + 4}{{3}^{2} \cdot 16 + 1} = 0.49 \qquad ( 16 )$$

The result in Equation (16) indicates that substituting one Conv2D by a SRNN layer reduces the number of model parameters. It is noted that using a separable convolution layer with a small kernel can be similar to SRNN in the number of parameters.

With respect to the number of multiplications, in embedded systems it is common to use the number of Multiply and Accumulate (MAC) operations in an algorithm as a good approximation of the computational complexity of the algorithm. For purposes of illustration, the number of additions will also be counted as MACs, although it is generally much smaller. Accordingly, the number of MACs of a Conv2D for an input of size of H×W×Cᵢₙ is given in Equation (17):

$$Conv 2 {D}_{MACs} = ( {k}^{2} \cdot {C}_{in} \cdot {C}_{out} + {C}_{out} ) \cdot H \cdot W \qquad ( 17 )$$

The number of MACs for a SRNN for an input size of H×W×Cᵢₙ is given in Equation (18):

$${SRNN}_{MACs} = 2 ( {C}_{in} {C}_{out} + {C}_{out}^{2} + 2 {C}_{out} ) \cdot H \cdot W \qquad ( 18 )$$

Therefore, using Equations (17) and (18), the ratio of the MACs is given in Equation (19):

$$\frac{{SRNN}_{MACs}}{Conv 2 {D}_{MACs}} = \frac{2 ( {C}_{in} + {C}_{out} ) + 4}{{k}^{2} \cdot {C}_{in} + 1} \qquad ( 19 )$$

As with the number of model parameters, Cₒᵤₜ is only present in the numerator, which means that when it is much larger than Cᵢₙ, the number of MACs will be higher in a SRNN layer. However, for a comparable Cᵢₙ and Cₒᵤₜ, assuming both are larger than 1, the ratio of MACs is 4/k², which is generally smaller than 1. As for the SWS-BiRNN layer, it has double the MACs compared to SRNN, so its ratio of MACs compared to Conv2D is 8/k², which is generally close to 1.

The advantage of SWS-BiRNN over convolution layers lies in its ability to get a large receptive field with no need to increase the number of model parameters or the kernel size. In small networks, to capture big or close objects in an image, either a Conv2D layer with a very big kernel or multiple such layers with small kernels must be used. One SWS-BiRNN layer can replace several convolution layers, thereby considerably reducing the number of model parameters and multiplications. Additionally, when using parallel execution on a Neural Processing Unit, there is an overhead of starting the processing of every layer that, in some cases, is related to rearrangement and duplication of the input values, which allows for the parallel operation. For small networks/layers, such overhead is not negligible. Consequently, replacing several Conv2D layers by one SWS-BiRNN layer can considerably reduce the inference time.

It is noted that a separable convolution is a private case of a Conv2D, which is able to represent 2D kernels with linearly dependent rows and columns. Similarly, SRNN is able to represent exponentially decaying weighting of the input that has its principal directions on the x-and y-axes. A more general, two-dimensional RNN (RNN2D) operation can be defined as in Equation (20):

$${h}_{jk} = tanh ( {W}_{ih} {x}_{jk} + {W}_{hk} {h}_{j , k - 1} + {W}_{hj} {h}_{j - 1 , k} + {W}_{jk} {h}_{j - 1 , k - 1} + b ) \qquad ( 20 )$$

Equation (20) can allow the principal direction of the input weighting to be diagonal or at any angle in the xy plane, when combined with a bidirectional operation.

Merely for purposes of illustration and not limitation, the improved performance of SWS-BiRNN can be illustrated by applying embodiments of the present invention to two conventional computer vision problems—object detection and classification. For object detection, a CNN network was trained on the COCO dataset. COCO is a conventional dataset for object detection. For purposes of the present illustration, the COCO dataset was used to detect only the person class. The CNN network outperforms YOLOv5 in object detection efficiency on embedded devices with limited resources, attributed to its optimal balance between the number of parameters and Tensor arena size. The architecture of the CNN model features a Backbone comprising a convolution layer followed by 8 Inverted Residual blocks. It includes a Neck with 9 convolution layers and 5 heads, each consisting of 4 convolution layers for Anchor boxes of varying sizes, emanating from different points within the Neck. This model specifically detects the ‘person’ object.

To assess the effectiveness of SWS-BiRNN on COCO, each CNN model head was replaced with an SWS-BiRNN layer, adjusting the channel count to align the parameter totals of both networks. This modified network, referred to herein as a Convolutional Recurrent Neural Network (CRNN), underwent evaluation under two conditions: varying grid sizes and input dimensions (256×256 and 480×640), which are significant factors in determining Tensor arena size. TABLE 1 provides a comparison between the CNN and CRNN models on the COCO dataset, with both models being equipped with a large parameter count, based on the F1 Score and AP50 object detection metrics for an input size of 480×640.

TABLE 1
Comparison between CNN and CRNN models on COCO dataset

| | | Tensor | Total | F1 | |
|---|---|---|---|---|---|
| Model | Parameters | Arena | Memory | Score | AP50 |
| CNN | 605K | 1.63M | 2.23M | 68.0 | 70.1 |
| CRNN | 597K | 1.63M | 2.22M | 67.4 | 68.5 |

The findings presented in TABLE 1 indicate that the larger CNN model, with a memory footprint of 2.22M-2.23M, marginally outperforms the CRNN in metrics like F1 Score and AP50.

For comparative analysis, YOLOv5 was also trained with similar total memory (parameters+tensor arena) as the compact CRNN. TABLE 2 provides a comparison of the CNN, CRNN, and YOLOv5 models on the COCO dataset, specifically targeting configurations with fewer parameters, evaluated on the F1 Score and AP50 object detection metrics for an input size of 256×256.

TABLE 2
Comparison between CNN, CRNN, and
YOLOv5 models on COCO dataset

| | | Tensor | Total | F1 | |
|---|---|---|---|---|---|
| Model | Parameters | Arena | Memory | Score | AP50 |
| CNN | 493K | 819K | 1.31M | 55.5 | 53.1 |
| CRNN | 530K | 778K | 1.3M | 56.3 | 53.8 |
| YOLOv5 | 101K | 1.24M | 1.34M | 44.4 | 39.7 |

As shown in TABLE 2, CRNN excels over both YOLOv5 and the CNN model in smaller configurations, with memory allocations between 1.3M-1.34M. These results highlight the superiority of SWS-BiRNN, particularly in networks with fewer parameters.

For classification, CIFAR 100 was trained on MobileNetV3-small with a width-multiplier of 0.5, incorporating 11 Inverted Residual blocks, a convolution layer, and three fully connected layers for the final classification. For CIFAR 100, SWS-BiRNN was evaluated by replacing the last Inverted Residual block of MobileNetV3-small with an SWS-BiRNN layer, which contains the most parameters in the model, creating the MobileNetV3-tiny-RNN. Additionally, to compare with a similarly sized model, another MobileNetV3-small model was adjusted to reduce the parameter count in its last Inverted Residual block. TABLE 3 provides a comparison of the accuracy of the three models on the CIFAR 100 dataset: the baseline MobileNetV3-small, a MobileNetV3-small variant with reduced parameters, and the MobileNetV3-tiny-RNN.

TABLE 3
Comparison of the accuracy of the three
models on the CIFAR100 dataset

| | | Tensor | Total | |
|---|---|---|---|---|
| Model | Parameters | Arena | Memory | Accuracy |
| MobileNetV3-small | 455K | 20K | 475K | 51.1 |
| (baseline) | | | | |
| MobileNetV3-small | 378K | 20K | 398K | 49.1 |
| (reduced parameters) | | | | |
| MobileNetV3-tiny-RNN | 377K | 20K | 397K | 50.3 |

As shown in TABLE 3, MobileNetV3-tiny-RNN exhibits lower accuracy relative to the larger MobileNetV3-small baseline. However, against the smaller variant of MobileNetV3-small with an equal parameter count, MobileNetV3-tiny-RNN demonstrates superior accuracy.

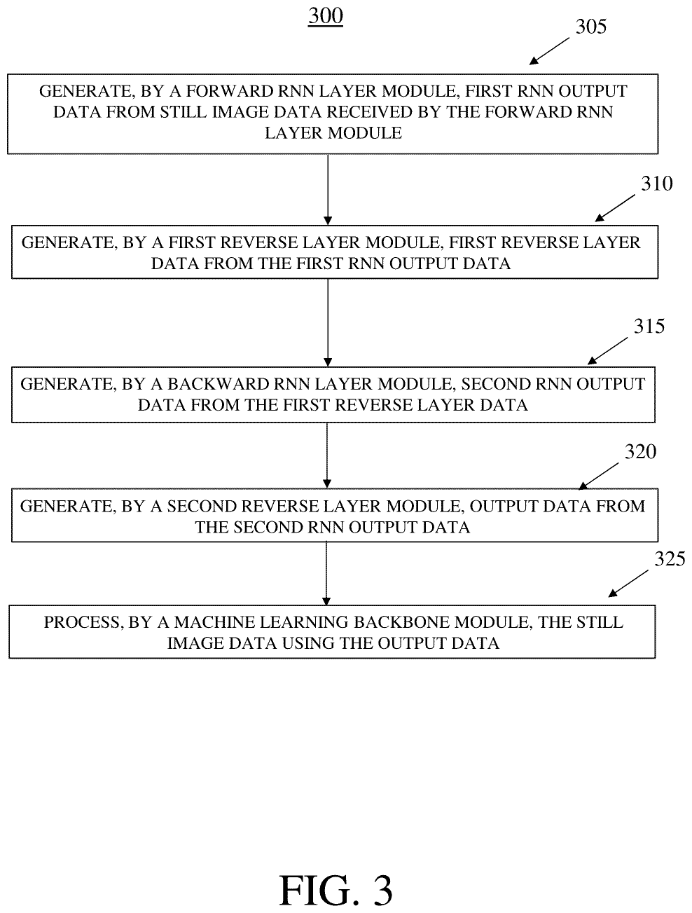

FIG. 3 is a flowchart of an example method 300 for processing still images using SWS-BiRNN layer units 104. The method 300 can be performed by, for example, the system 100 of FIG. 1. At block 305, a first forward RNN layer module can generate first RNN output data from still image data received by the first forward RNN layer module. At block 310, a first reverse layer module can generate first reverse layer data from the first RNN output data. At block 315, a first backward RNN layer module can generate second RNN output data from the first reverse layer data. According to exemplary embodiments of the present invention, the same machine learning model weights can be shared between the first forward RNN layer module and the first backward RNN layer module. At block 320, a second reverse layer module can generate output data from the second RNN output data. At block 325, a machine learning backbone module can process the still image data using the output data. For example, the machine learning backbone module can perform object detection, classification, estimation, or other suitable computer vision processing tasks on the still image data using the output data. In some implementations of the present invention, the generating of blocks 305-320 and the processing of block 325 can be performed by at least one data processor on a resource-constrained hardware device, such as, for example, an embedded device, an edge device, or the like.

In some aspects, the first RNN output data includes a one-dimensional sequence of features associated with a still image for processing using the RNNs. In some aspects, the first RNN output data includes an output of a first RNN being applied to the one-dimensional sequence. In some aspects, the first reverse layer data includes the first RNN output data and first reversed data, the first reversed data including the one-dimensional sequence of features expressed in a reversed order. In some aspects, the second RNN output data includes the first RNN output data and an output of the first RNN being applied to the first reversed data. In some aspects, the second reverse layer data includes a sum of the first RNN output data and a reversed order output of the first RNN being applied to the first reversed data. In some aspects, the second reverse layer data includes Weight-Shared Bi-Directional RNN (WS-Bi-RNN) data given as WS-BiRNN(X)=RNN₁(X)+Flip(RNN₁ (Flip(X))), where X is the one-dimensional sequence of features, RNN₁(⋅) is an operator applying the first RNN to its operand, and Flip(⋅) is an operator which reverses the order of its operand.

In some aspects, the still image data includes a two-dimensional sequence of feature vectors associated with a still image for processing using the RNNs. In some aspects, the method 300 further includes generating, by a second forward RNN layer module, third RNN output data from the second reverse layer data, generating, by a third reverse layer module, third reverse layer data from the third RNN output data, generating, by a second backward RNN layer module, fourth RNN output data from the third reverse layer data, wherein machine learning model weights are shared between the second forward RNN layer module and the second backward RNN layer module, and generating, by a fourth reverse layer module, fourth reverse layer data from the fourth RNN output data, wherein the machine learning backbone module further processes the still image data based at least in part on the fourth reverse layer data.

In some aspects, the third RNN output data includes an output of a second RNN being applied to the second reverse layer data, the second RNN being different from an RNN associated with the first forward RNN layer module and the first backward RNN layer module. In some aspects, the third reverse layer data includes the third RNN output data and second reversed data, the second reversed data including the second reverse layer data expressed in a reversed order. In some aspects, the fourth RNN output data includes the third RNN output data and an output of the second RNN being applied to the second reversed data. In some aspects, the second reverse layer data includes Weight-Shared Bi-Directional RNN (WS-BiRNN) data given as WS-BiRNN₁(X)=RNN₁(X)+Flip(RNN₁(Flip(X))), where X is the two-dimensional sequence of features, RNN₁(⋅) is a first RNN operator associated with the first forward RNN layer and the first backward RNN layer, the first RNN operator configured to operate on rows of the two-dimensional sequence of features, and Flip(⋅) is an operator which reverses the order of its operand. In some aspects, the fourth reverse layer data includes WS-BiRNN₂(Y)=RNN₂(Y)+Flip(RNN₂(Flip(Y))), where Y is the second reverse layer data, RNN₂(⋅) is a second RNN operator which applies the second RNN to its operand, the second RNN operator configured to operate on columns of the two-dimensional sequence of features, and Flip(⋅) is an operator which reverses the order of its operand. In some aspects, the fourth reverse layer data includes Separable Weight-Shared Bi-Directional RNN (SWS-BiRNN) data given as SWS-BiRNN(X)=WS-BiRNN₂(WS-BiRNN₁(X)^{T})^{T}.

The strategic replacement of multiple CNN layers with a solitary SWS-BiRNN layer can be particularly beneficial within compact network structures. Such an approach renders embodiments of the present invention as a highly suitable option for deployment on edge and other like devices where resource constraints are prevalent. Embodiments of the present invention can improve computer processing and lower memory requirements for processing still images using resource-constrained hardware devices. For example, embodiments of the present invention can conserve memory due to the machine learning model having a reduced number of weights and enhance performance while maintaining the same weight count in the model. Additionally, the use of an RNN-based machine learning model can require fewer layers, which potentially allows for quicker inference times.

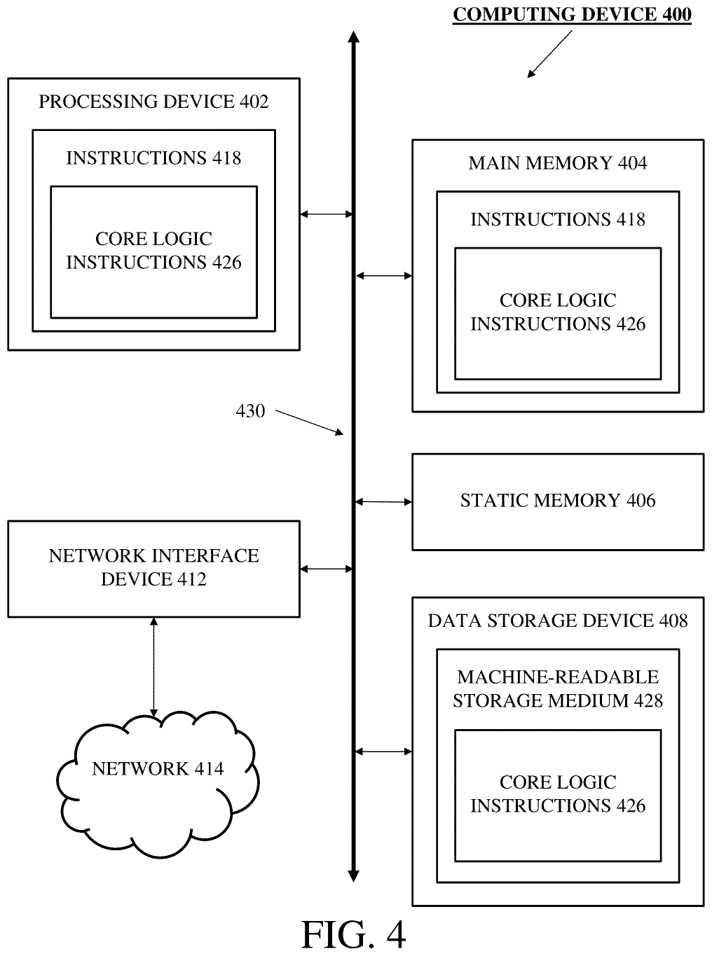

FIG. 4 is a block diagram of an example computing device 400 that may perform one or more of the operations described herein, in accordance with the present embodiments. The computing device 400 may be connected to other computing devices in a LAN, an intranet, an extranet, and/or the Internet. The computing device 400 may operate in the capacity of a server machine in client-server network environment or in the capacity of a client in a peer-to-peer network environment. The computing device 400 may be provided by a personal computer (PC), a set-top box (STB), a server, a network router, switch or bridge, or any machine capable of executing a set of instructions (sequential or otherwise) that specify actions to be taken by that machine. Further, while only a single computing device 400 is illustrated, the term “computing device” shall also be taken to include any collection of computing devices that individually or jointly execute a set (or multiple sets) of instructions to perform the methods discussed herein.

The example computing device 400 may include a computer processing device 402 (e.g., a general purpose processor, ASIC, etc.), a main memory 404, a static memory 406 (e.g., flash memory or the like), and a data storage device 408, which may communicate with each other via a bus 430. The computer processing device 402 may be provided by one or more general-purpose processing devices such as a microprocessor, central processing unit, or the like. In an illustrative example, computer processing device 402 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 402 may also comprise one or more special-purpose processing devices, such as an application specific integrated circuit (ASIC), a field programmable gate array (FPGA), a digital signal processor (DSP), network processor, or the like. The computer processing device 402 may be configured to execute the operations described herein, in accordance with one or more aspects of the present disclosure, for performing the operations and steps discussed herein.

The computing device 400 may further include a network interface device 412, which may communicate with a network 414. The data storage device 408 may include a machine-readable storage medium 428 on which may be stored one or more sets of instructions, e.g., instructions for carrying out the operations described herein, in accordance with one or more aspects of the present disclosure. Instructions 418 implementing core logic instructions 426 may also reside, completely or at least partially, within main memory 404 and/or within computer processing device 402 during execution thereof by the computing device 400, main memory 404 and computer processing device 402 also constituting computer-readable media. The instructions may further be transmitted or received over the network 414 via the network interface device 412.

While machine-readable storage medium 428 is shown in an illustrative example to be a single medium, the terms “computer-readable storage medium” or “computer program product” or the like should be taken to include a single medium or multiple media (e.g., a centralized or distributed database and/or associated caches and servers) that store the one or more sets of instructions. The terms “computer-readable storage medium” or “computer program product” or the like shall also be taken to include any medium that is capable of storing, encoding or carrying a set of instructions for execution by the machine and that cause the machine to perform the methods described herein. The terms “computer-readable storage medium” or “computer program product” or the like shall accordingly be taken to include, but not be limited to, solid-state memories, optical media, magnetic media, and the like.

Embodiments of the subject matter and the operations described in this disclosure can be implemented in digital electronic circuitry, or in computer software, firmware, or hardware, including the structures disclosed in this disclosure and their structural equivalents, or in combinations of one or more of them. Embodiments of the subject matter described in this disclosure can be implemented as one or more computer programs, i.e., one or more modules of computer program instructions, encoded on computer storage medium for execution by, or to control the operation of, one or more data processors or data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processor or a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by one or more data processors or data processing apparatus on data stored on one or more computer-readable storage devices or received from other sources.

The terms “data processor” or “data processing apparatus” encompass all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor, a light emitting diode (LED) monitor, or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like. In addition, a computer can interact with a user by sending resources to and receiving resources from a device that is used by the user; for example, by sending web pages to a web browser on a user's client device in response to requests received from the web browser.

Embodiments of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by at least one data processor or data processing apparatus, cause the at least one data processor or data processing apparatus to perform the actions.

Reference throughout this disclosure to “one embodiment” or “an embodiment” means that a particular feature, structure, or characteristic described in connection with the embodiments included in at least one embodiment. Thus, the appearances of the phrase “in one embodiment” or “in an embodiment” in various places throughout this disclosure are not necessarily all referring to the same embodiment. In addition, the term “or” is intended to mean an inclusive “or” rather than an exclusive “or.”

While this disclosure contains many specific implementation details, these should not be construed as limitations on the scope of any inventions or of what may be claimed, but rather as descriptions of features specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations and/or logic flows are depicted in the drawings and/or described herein in a particular order, this should not be understood as requiring that such operations and/or logic flows be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

What is claimed is:

1. A method for processing still images using recurrent neural networks (RNNs), comprising:
generating, by a first forward RNN layer module, first RNN output data from still image data received by the first forward RNN layer module;
generating, by a first reverse layer module, first reverse layer data from the first RNN output data;
generating, by a first backward RNN layer module, second RNN output data from the first reverse layer data, wherein machine learning model weights are shared between the first forward RNN layer module and the first backward RNN layer module;
generating, by a second reverse layer module, second reverse layer data from the second RNN output data; and
processing, by a machine learning backbone module, the still image data based at least in part on the second reverse layer data, wherein the generating and the processing are performed by at least one data processor on a resource-constrained hardware device.

2. The method of claim 1, wherein the still image data comprises a one-dimensional sequence of features associated with a still image for processing using the RNNs.

3. The method of claim 2, wherein the first RNN output data comprises an output of a first RNN being applied to the one-dimensional sequence of features.

4. The method of claim 3, wherein the first reverse layer data comprises the first RNN output data and first reversed data, the first reversed data comprising the one-dimensional sequence of features expressed in a reversed order.

5. The method of claim 4, wherein the second RNN output data comprises the first RNN output data and an output of the first RNN being applied to the first reversed data.

6. The method of claim 5, wherein the second reverse layer data comprises a sum of the first RNN output data and a reversed order output of the first RNN being applied to the first reversed data.

7. The method of claim 5, wherein the second reverse layer data comprises Weight-Shared Bi-Directional RNN (WS-BiRNN) data given as “WS-BiRNN(“X”)=“ [symbol] RNN” [symbol] _1”(“X”)+Flip(“ [symbol] RNN” [symbol] _1 (“Flip” (X))), where X is the one-dimensional sequence of features, RNN₁(⋅) is an operator applying the first RNN to its operand, and Flip(⋅) is an operator which reverses the order of its operand.

8. The method of claim 1, wherein the still image data comprises a two-dimensional sequence of feature vectors associated with a still image for processing using the RNNs.

9. The method of claim 8, further comprising:
generating, by a second forward RNN layer module, third RNN output data from the second reverse layer data;
generating, by a third reverse layer module, third reverse layer data from the third RNN output data;
generating, by a second backward RNN layer module, fourth RNN output data from the third reverse layer data, wherein machine learning model weights are shared between the second forward RNN layer module and the second backward RNN layer module;
generating, by a fourth reverse layer module, fourth reverse layer data from the fourth RNN output data;
wherein the machine learning backbone module further processes the still image data based at least in part on the fourth reverse layer data.

10. The method of claim 9, wherein the third RNN output data comprises an output of a second RNN being applied to the second reverse layer data, the second RNN being different from an RNN associated with the first forward RNN layer module and the first backward RNN layer module.

11. The method of claim 10, wherein the third reverse layer data comprises the third RNN output data and second reversed data, the second reversed data comprising the second reverse layer data expressed in a reversed order.

12. The method of claim 11, wherein the fourth RNN output data comprises the third RNN output data and an output of the second RNN being applied to the second reversed data.

13. The method of claim 12, wherein the fourth reverse layer data comprises a sum of the third RNN output data and a reversed order output of the second RNN being applied to the second reversed data.

14. The method of claim 12, wherein the second reverse layer data comprises Weight-Shared Bi-Directional RNN (WS-BiRNN) data given as [symbol] WS-BiRNN [symbol] _1”(“X”)=“ [symbol] RNN” [symbol] _1”(“X”)+Flip(“ [symbol] RNN” [symbol] _1 (“Flip” (X))), where X is the two-dimensional sequence of features, RNN₁(⋅) is a first RNN operator associated with the first forward RNN layer and the first backward RNN layer, the first RNN operator configured to operate on rows of the two-dimensional sequence of features, and Flip(⋅) is an operator which reverses the order of its operand.

15. The method of claim 14, wherein the fourth reverse layer data comprises [symbol] WS-BiRNN [symbol] _2”(“Y”)=“ [symbol] RNN” [symbol] _2”(“Y”)+Flip(“ [symbol] RNN” [symbol] _2 (“Flip” (Y))), where Y is the second reverse layer data, RNN₂(⋅) is a second RNN operator which applies the second RNN to its operand, the second RNN operator configured to operate on columns of the two-dimensional sequence of features, and Flip(⋅) is an operator which reverses the order of its operand.

16. The method of claim 15, wherein the fourth reverse layer data comprises Separable Weight-Shared Bi-Directional RNN (SWS-BiRNN) data given as “SWS-BiRNN (“X”)=“ [symbol] WS-BiRNN” [symbol] _2”(“ [symbol] “WS-BiRNN” [symbol] _1(X)\hat{ }T)\hat{ }T.

17. A system for processing still images using recurrent neural networks (RNNs), comprising:
at least one data processor and memory storing instructions, which, when executed by the at least one data processor, cause the at least one data processor to perform operations comprising:
generating, by a first forward RNN layer module, first RNN output data from still image data received by the first forward RNN layer module;
generating, by a first reverse layer module, first reverse layer data from the first RNN output data;
generating, by a first backward RNN layer module, second RNN output data from the first reverse layer data, wherein machine learning model weights are shared between the first forward RNN layer module and the first backward RNN layer module;
generating, by a second reverse layer module, second reverse layer data from the second RNN output data; and
processing, by a machine learning backbone module, the still image data based at least in part on the second reverse layer data, wherein the generating and the processing are performed by the at least one data processor on a resource-constrained hardware device.

18. The system of claim 17, wherein the system further comprises a plurality of RNN processing units, and a first RNN processing unit of the plurality of RNN processing unit comprises the first forward RNN layer module, the first reverse layer module, the first backward RNN layer module, and the second reverse layer module.

19. The system of claim 18, wherein each RNN processing unit of the plurality of RNN processing units is associated with a different RNN for processing the still image data.

20. A non-transitory computer program product storing executable instructions, which, when executed by at least one data processor forming part of at least one computing system, implement operations comprising:
generating, by a first forward RNN layer module, first RNN output data from still image data received by the first forward RNN layer module;
generating, by a first reverse layer module, first reverse layer data from the first RNN output data;
generating, by a first backward RNN layer module, second RNN output data from the first reverse layer data, wherein machine learning model weights are shared between the first forward RNN layer module and the first backward RNN layer module;
generating, by a second reverse layer module, second reverse layer data from the second RNN output data; and
processing, by a machine learning backbone module, the still image data based at least in part on the second reverse layer data, wherein the generating and the processing are performed by the at least one data processor on a resource-constrained hardware device.
